(19) United States
(12) Patent Application Publication
(10) Pub. No.: US 2010/0027397 A1
(43) Pub. Date: Feb. 4, 2010

(54) TRACKING BY CROSS CORRELATING CENTRAL APERTURES OF MULTIPLE BEAMS

(75) Inventors: Ruud Vlutters, Eindhoven (NL); Bin Yin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,383

(22) PCT Filed: Dec. 7, 2005
(86) PCT No.: PCT/IB05/54106

§ 371 Date: Jun. 21, 2007

Related U.S. Application Data
(60) Provisional application No. 60/639,449, filed on Dec. 23, 2004.

(51) Int. Cl. G11B 20/18

(52) U.S. Cl. 369/53.17; G9B/20.046

(57) ABSTRACT

The present invention provides a method and apparatus for robust tracking at narrow track-pitches on optical discs, enabling higher densities on Blu-ray Discs (5) as well as near-field discs. Increasing radial density results in loss of radial diffraction within the numerical aperture of the lens. Due to this loss in diffraction, current tracking methods, such as Push-Pull and Differential Phase Detection (DPD), will stop working. The invention provides a method and apparatus that relies on cross-correlating the central aperture (CA) signals of 3 optical spots (22, 24, 26) that are positioned such that there are a central spot (24) and spots (22, 26) positioned to the left (22) and right (26) of the central spot (4). By using CA signals, the tangential diffraction is used, which is hardly affected by a track-pitch reduction.

The present invention relates to tracking with optical discs, and more particularly to preserving tracking error signals in optical discs that have a very small track pitch.

Optical disc storage systems commonly employ run-length limited (RLL) modulation code that is used in optical disc storage systems to improve the transmission performance according to the optical channel characteristics. A run is defined as a consecutive sequence of binary bits of the same type (zeros or ones) recorded on the disc. The length is the number of bits in the sequence. For example the binary sequence of bits, 00100 is illegal while the binary sequence 001100 is legal. In Blu-ray disc format, the shortest sequence has a length of 2, referred to as I2, and the longest sequence has a length of 9, referred to as I9. It should be noted that I8 is the longest run length for data and the maximum run length of I9 is only employed for frame syncs to indicate the beginning and the end of a data frame.

Diffraction occurs within light from a laser spot that is reflected by the disc information layer having a grating structure, specifically, the lands and pits contained within an information track in the tangential direction and the periodic track structure in the radial direction. The reflected light will be split into bundles, called diffraction orders, which propagate back onto the detector in a diverging manner. The light intensity variation during the spot scanning along tracks, for the purpose of data detection, and crossing tracks, for the purpose of tracking, needs overlap of the 0-th diffraction order and +1/−1 diffraction orders. In cases for very high spatial frequencies, for example in the case of very small track pitches, the overlap in the radial direction disappears for all practical purposes and any tracking method requiring radial diffraction will fail. DPD tracking uses the combination of tangential and radial diffractions and PP tracking relies purely on radial diffraction.

Optical disc technology has been a constantly evolving art that continues to increase the storage capacity of optical disc media. An example of the evolving optical disc technology that is increasing the density of optical media, is the Blu-ray format. The Blu-ray format illustrates the concept that storage capacity on optical disc media can be increased by further reducing the wavelength and enlarging the numerical aperture (NA). By doing so, the bit length (tangential density) and track pitch (radial density) can be squeezed compared to those in CD and DVD formats due to a smaller focused laser spot. Optical disc media conforming to the Blu-ray format places tracks closer together at a track-pitch of 320 nm (740 nm for DVD).

Reducing the track pitch further can lead to an even higher capacity. However, some side effects will take place. Employing track pitches that are less than 320 nm has resulted in more cross-talk from the data being close together. Eliminating cross-talk has been a major focus in more recent optical disc media formats.

Employing track pitches below 320 nm greatly reduces the tracking error signal resulting in substantial deterioration in tracking performance and cross talk. The reduction in the tracking error signal results in tracking degradation to the point that the optical beam often drifts off-track.

Cross-talk results in the central aperture channel. A central aperture channel as used herein is defined as the summation of signals from multiple detectors that receive reflected light from a light spot, typically four detectors. The prior art has shown that cross talk can be reduced using 3-spot cross talk cancellation techniques. Unfortunately, these prior art references do not satisfactorily address degradations in the tracking error signal that also results from using track pitches below 320 nm.

A single-spot Differential Phase Detection (DPD) signal relies on both tangential diffraction and radial diffraction. Tangential diffraction is diffraction from the data marks within the tracks, specifically, the I2-I8 marks contained on discs within Blu-ray format. Tangential diffraction is typically only available when there is written data on the disc. Radial diffraction is diffraction that results from the grating structure of the tracks. The grating structure of the tracks is a very periodic structure, in which the track-pitch determines the diffraction angles. Both diffraction types should interfere with the 0-th order reflection (no diffraction) in order to obtain a reliable DPD signal. Therefore this method has problems at reduced track-pitches. Using push-pull tracking, based solely on radial diffraction is even worse.

From the foregoing discussion, it should be readily apparent mat there remains a need within the art for a method and apparatus that preserve the tracking error signal for optical discs having small track pitches.

This invention addresses the shortcomings within the prior art by providing a method and apparatus for tracking that scales more effectively at short track-pitches compared to DPD and Push-Pull tracking methods. The Blu-ray disc format has been already standardized such that there are currently three capacities, namely, 23.3 GB, 25 GB and 27 GB. In all three cases, the track pitch is set to 320 nm. The present invention also addresses needs in current capacities as well addressing the aforementioned problems to further reducing track pitches to increase the capacity. The invention generates a plurality of optical tracking spots (preferably the use of 3 optical spots), which can be obtained by employing a grating in front of the laser, and a plurality (preferably 3) of photo-detectors to detect reflections from the spots. A simple formula is employed to calculate the tracking error signal from the 3-detectors. The equation employed by the invention determines from the reflection of the spots the tangential diffraction only resulting in tracking that scales more effectively for short track-pitches compared to DPD and Push-Pull tracking methods.

These objects of the invention are provided for by: generating a tracking error signal from a plurality of light spots, wherein the light spots are incident so that they are spaced apart in a radial direction by a predetermined distance on a spinning optical media disc, the radial direction being measured from a center of the disc to an outside edge of the disc, receiving light reflected from each of the light spots, and correlating respective positions of the light spots in a tangential direction orthogonal to the radial direction to obtain the tracking error signal.

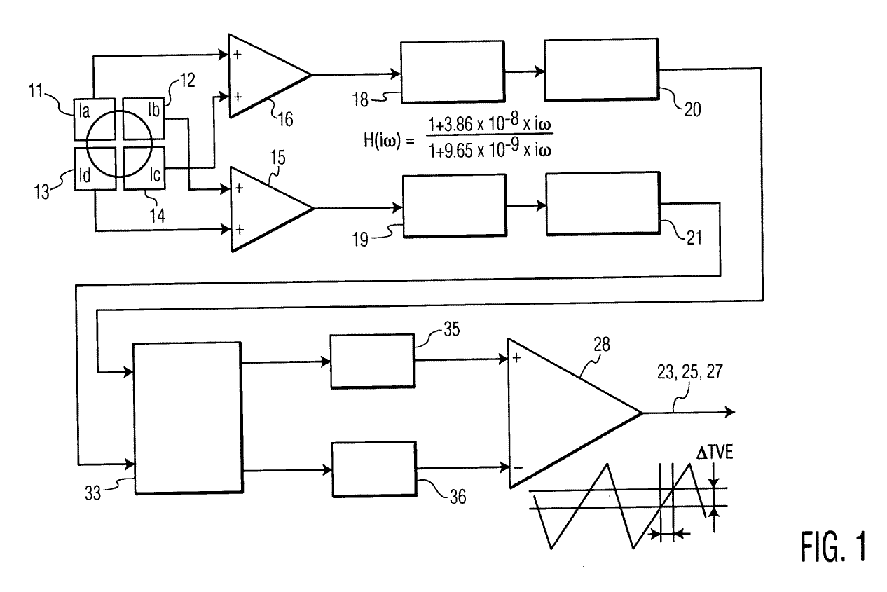

FIG. 1 is a diagram illustrating the manner of obtaining a DPD signal;

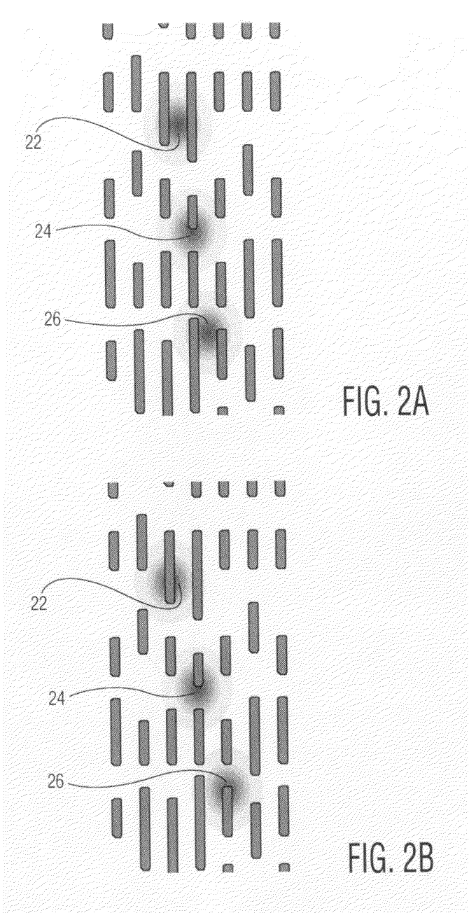

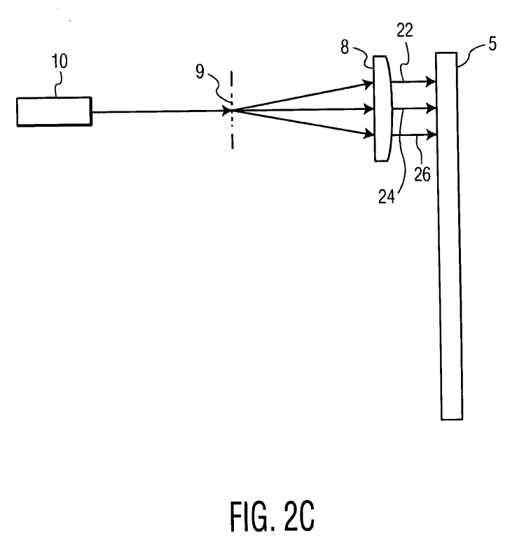

FIG. 2a is an illustration for positioning 3-spots with a central spot of the central track and adjacent left and right spots on the land areas between the central track and adjacent left and right tracks;

FIG. 2b is an illustration for positioning 3-spots with a central spot of the central track and adjacent left and right spots on adjacent left and right tracks;

FIG. 2c is an illustration of a laser with a grating to form multiple spots on a disc;

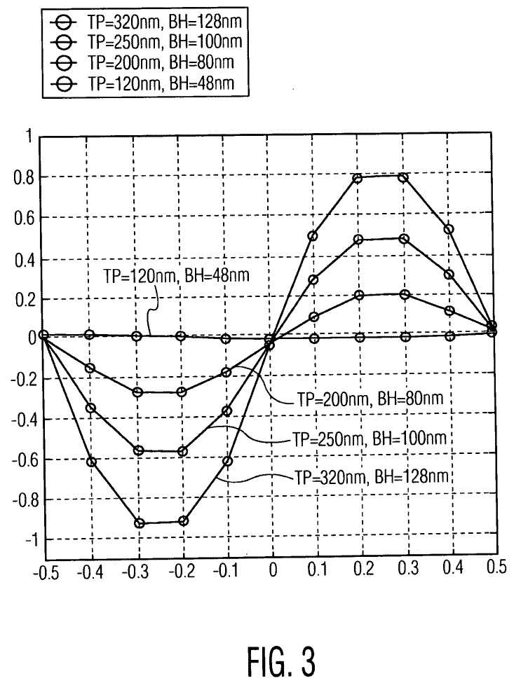

FIG. 3 is an illustration of a simulation for a tracking error signal for 4 different track pitches;

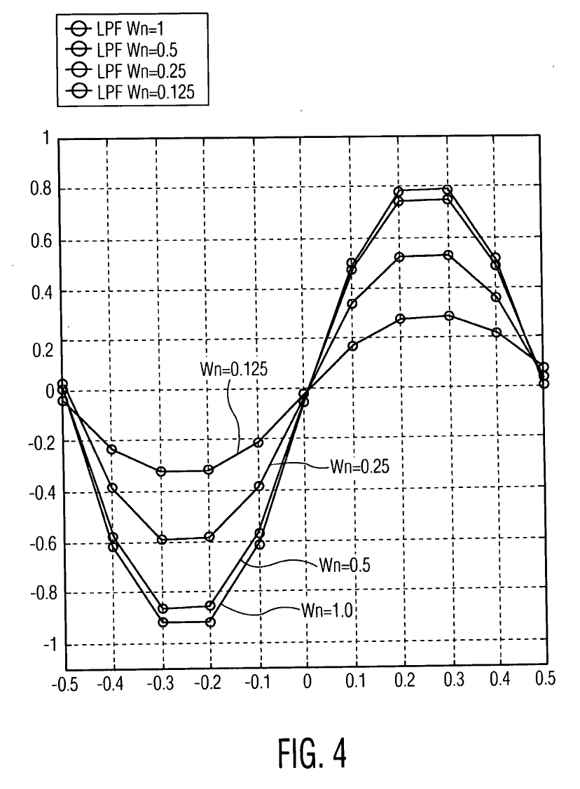

FIG. 4 illustrates the effect of low pass filtering on the tracking error signals of FIG. 3;

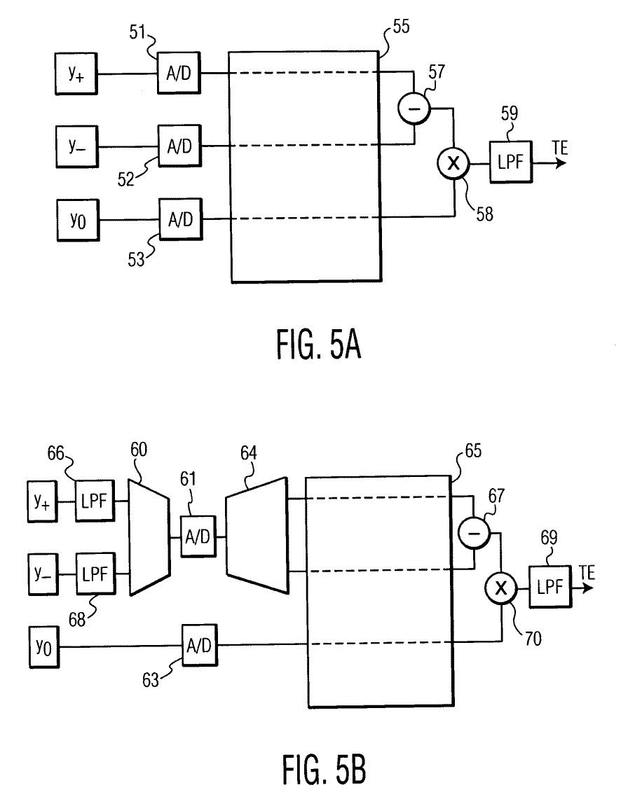

FIG. 5a is a diagram for full bandwidth implementation of correlating three light spots; and

FIG. 5b is a diagram for a half bandwidth implementation of correlating three light spots.

Referring to FIG. 1, a Differential Phase Detection (DPD) diagram is illustrated as used within the prior art for detecting light that has reflected from an optical disc from a single light spot. Differential Phase Detection has been used within the prior art for generating a tracking error (TE) signal. Using DPD as illustrated in FIG. 1, the TE is generated by differences within the phases of received signals in diagonally opposite light receiving portions of the four-divided light detectors 11, 12, 13, 14. The signal received by light detectors 11, 12, 13, 14 are fed into amps 15, 16 and arranged such that tangential diffraction can be determined from a difference between the upper two and lower two detector quadrants, and radial diffraction can be determined by a difference between the two left and two right detector quadrants. This procedure of using DPD is well known within the art. As illustrated in FIG. 1, equalizers 18, 19, level comparators 20, 21, phase comparator 33, low pass filters 35, 36 and differential amp 28 operate to determine the tracking error signal. The functions of equalizers 18, 19, level comparators 20, 21, phase comparator 33, low pass filters 35, 36 and differential amp 28 are known within the art. Equalizers H(iω) perform equalization by performing a first order high pass filtering, mainly for the boosting of high frequency components, such as I2s. Both tangential and radial diffraction types should interfere with the 0-th order reflection (no diffraction) in order to obtain a reliable DPD signal. Therefore the DPD method has problems at reduced track-pitches. Using push-pull tracking, based solely on radial diffraction is even worse.

FIGS. 2a and 2b illustrate the inventive concept of positioning 3-spots to obtain a tracking error (TE) signal from a laser 10. The light beam from laser 10 is directed towards disc 5 and split into 3 three beams of light through grating 9 and focused on the desired area of disc 5 by optics 8 to form multiple spots 22, 24, 26. A collimating lens can be employed to the beam of light from laser 10 before grating 9, after grating 9 or incorporated into optics 8. The invention employs a plurality of optical tracking spots, preferably 3 optical tracking spots, to generate the TE signal. Multiple spots can be obtained by employing a grating in front of the laser as illustrated in FIG. 2c, with 3 photo-detectors arranged such that each one of the photo-detectors will receive light that is reflected from the disc for one of the spots. The photo-detectors used by the preferred embodiment are of the same type as those used to facilitate DPD illustrated in FIG. 1, except that there are multiple photodetectors for the multiple spots. The invention will use the light detected from each of the spots 22, 24, 26 to create signals that are used to generate central aperture signatures for light reflect from spots 22, 24, 26 via disc 5. In both FIGS. 2a and 2b, there is a center spot 24 on the track for which the TE is to be generated and a left spot 22 and right spot 26 radially spaced from the center spot 24. FIG. 2a illustrates the positioning of the left and right spots on areas between the adjacent tracks and the central track, such as a land area. FIG. 2b illustrates the positioning of the left and right spots 22, 26 on the adjacent tracks to the central track 24.

The present embodiment employs 3-spots in a configuration as shown in FIGS. 2a, 2b and 2c, a left spot 22, a central spot 24 and a right spot 26. Central aperture signals 23, 25 and 27 are respectively obtained for each of the three spots 22, 24 and 26. Each of the 3 central aperture signals 23, 25 and 27 is obtained as the sum from 4-quadrants of the photodetector relegated to receive reflected light for a particular one of spots 22, 24 and 26, in a manner similar to the DPD method illustrated in FIG. 1 for a single spot. Accordingly, the apparatus of the preferred embodiment will employ three 4-quadrant photodetectors. It is specifically envisioned that the side spots can be positioned differently to get optimal tracking error signals, dependent on the track-pitch. By cross-correlating the left aperture signal 23 and central aperture signal 25 and subtracting this from the correlation of the right aperture signal 27 and central aperture signal 25, a quantity is obtained that is sensitive to the track error. In instances where all 3-spots are moving to the left away from the central track, more correlation with the central track signal in the right aperture signals 27 from the right spot signal 26 is measured, than in the left aperture signal 23 from the left spot 22. The overlap of the optical spots remains the same, but the data-patterns reflected from spots 22, 24 and 26 changes when they are moved. The manner in which the changes in data patterns are sensed is dependent on the derivative of the optical spot. The derivative as used herein refers to the slope steepness of the optical spot profile when observed along the radial direction. Moving spots 22, 24 and 26 by small amounts to the left or right does not result in a significant difference in the central aperture signal 25 of the central spot 24 that is related to the data-pattern in the central track, because the optical spot is almost flat at its top. Moving spots 22, 24 and 26 by small amounts to the left or right will increase/decrease the amount of information related to the central track reflected by the left spot 22 and right spot 26 because they will then be sensing the central track with the steep sides of the optical distribution. Additionally, when all 3-spots 22, 24 and 26 are moving to the right, the correlation of the left spot 22 with the central spot 24 becomes stronger, and the correlation of the central spot 24 with the right spot 26 becomes weaker.

The calculation of the correlation according to the preferred embodiment of the invention is done on sample-per-sample bases, as illustrated in Equation 1.

TE(t)=y₀(t)*[y₊(t+Δ)−y₋(t−Δ)] Equation 1

TE(t) is calculated on a sample basis and, therefore, is a high frequency signal. In order to use TE(t) for tracking purposes, it is preferably lowpass filtered to remove high frequency noise. The lowpass filtered version of TE(t) results in a DC-component, referred to herein as TE^{LPF}(t). It is the DC-component in this signal (TE^{LPF}(t)) that is preferably used as the tracking error.

In Equation 1, y₀(t) denotes the central aperture signal 25 from the central spot 24, and y₊(t+Δ) denotes the central aperture signals 27 for the respective right spot 26, y₋(t−Δ) denotes the central aperture signals 23 for the respective left spot 22 and Δ represents the time-shift. The central aperture signals 23, 27 of the left and right side-spots 22, 26 are preferably electronically shifted (delayed/advanced) to be in phase with the central spot 24. The time-shift is referred to in Equation 1 as Δ, and Δ is preferably given by the vertical (along the track direction) spot separation divided by the disc velocity.

A software simulation based on scalar diffraction is illustrated in FIG. 3 to prove the feasibility of the invention as previously described. In FIG. 3, the tracking-error signals shown are obtained according to Equation 1 for 4 different track-pitches in a BD-like optical system. The tracking-error signals are calculated at full band-width with the side-spots in between the tracks.

In FIG. 3, the tracking-error versus track-offset is calculated over ˜1000 randomly chosen channel bits with 17 parity preserved (PP) modulation. As will be readily apparent to those skilled in the art, the tracking error signals in FIG. 3 look very similar to signals obtained using the push-pull channel, therefore, a PID controllers that are used in push-pull based tracking systems can be used to remain for tracking within the invention. Here, tracking should start at the moment the tracking error passes 0 with a positive slope. From the curves at different track-pitches, it can be seen that reducing the track-pitch will reduce the tracking-error signal. For example at TP=250 nm, more than half of the amplitude of the signal received in the case for TP=320 nm remains; which is much better than in the case of push-pull that vanishes completely at TP=250 nm under BD-conditions.

FIG. 4 is a graph illustrating the effects on the central aperture signals of a low pass filter that is applied to limit bandwidth. As illustrated in FIG. 4, it is advantageous to reduce the bandwidth while performing the above discussed calculation for cross-correlation. On one hand, reduced side-spot intensity effectively limits the signal-to-noise ratio and accordingly the bandwidth of signals received from the side spots. On the other hand, the lower the clock-frequency used during the calculation, the easier the implementation. FIG. 4 illustrates the amplitude of the calculated track-error signal at different bandwidths. As can be seen, halving the bandwidth (LPF Wn=0.5) has minimal influence on the amplitude of the tracking error signal as compared to full bandwidth (LPF Wn=1.0), and quartering the bandwidth (LPF Wn=0.25) results in only a 40% reduction of the tracking error signal from full bandwidth. This illustrates the potential in reducing bandwidth, while maintaining a reliable track-error signal. Therefore, the preferred embodiment of the invention employs a low pass filter that limits the bandwidth to one half.

Low pass filters 66, 68 that limit the bandwidth by one half can be implemented using a single A/D converter 61 that receives the output of multiplexer 60. Demultiplexer 64 can select the digitized, low pass filtered version of side spots y₊, y₋ for correlation within main spot y₀. The correlations as described above can be implemented by the synchronization block 65 phase matching y₊, y₋, y₀ in a first step by correlating a first of the side spots y₊, y₋ (for example the left beam) with the central spot y₀, and in a second step by correlating a second of the side spots y₊, y₋ (for example the right spot) with the central spot y₀. Subtractor 67 then takes the difference of side spots y₊, y₋ which is multiplied by multiplier 68 to arrive at the complete correlation as described in Equation 1. This correlation is then low pass filtered by LPF 69 in a manner similar to that described above in FIG. 5a.

It will be readily understood by those skilled in the art that in FIG. 5b the correlation can be realized either first subtracting y₊ from y₋ and then being multiplied with y₀, as depicted there, or first correlating y₊ and y₋ with y₀ respectively and then doing subtraction. In order to execute at a full bandwidth, zero-padding for side spot Central Aperture signals needs to be done which is accomplished by synchronization block. The invention has shown that a reliable tracking error can be obtained by using ˜1000 channel bits for the cross-correlation. Due to the limited amount, the expected bandwidth can be ˜66 KHz (channel bit frequency/1000), which is more than enough for a radial tracking servo. It should be noted that at 1×BD the channel bit frequency is 66 MHz.

The preferred embodiments of the invention are for use in the newer generation of optical storage discs such as Blu-ray disc of extended formats and near field discs, where both tangential and radial densities will be pushed close to or beyond the resolution of the optical spot. It will be readily apparent to those skilled in the art that implementations other than these preferred embodiments are possible. Therefore, the scope of the invention should be measured by the appended claims.

1. A method for generating a tracking error signal comprising:
generating (9) a plurality of light spots (22, 24, 26);
placing (8) the light spots spaced apart in a radial direction by a predetermined distance on a spinning optical media disc (5), wherein the radial direction is measured from a center of the disc to an outside edge of the disc;
receiving (11, 12, 13, 14) light reflected from each of the light spots;
correlating respective positions of the light spots in a tangential direction orthogonal to the radial direction to obtain the tracking error signal.

2. The method of claim 1 wherein generating the plurality of light spots further comprises generating the spots such that a predetermined center position exists within the plurality of spots.

3. The method of claim 2 wherein correlating further comprises determining the predetermined center position by taking an average of positions received from reflected light for the plurality of spots.

4. The method of claim 1 wherein generating the plurality of light spots further comprises generating on odd number of spots with a center spot being placed on a track for which the tracking error signal is to be generated and radially spacing a remaining of the spots other than the center spot on either side of the track.

5. The method of claim 4 wherein generating further comprises placing the remaining of the spots on tracks adjacent to the track.

6. The method of claim 4 wherein generating further comprises placing the remaining of the spots on land areas adjacent to the track.

7. The method of claim 4 wherein correlating further comprises application of an equation of the form:
TE(t)=y₀(t)*[y₊(t+Δ)−y₋(t−Δ)]
wherein, y₀(t) represents light reflected from the center spot, y₊(t+Δ) represents light reflected from the remaining of the spots spaced radially to the right of the center spot, y₋(t−Δ) represents light reflected from the remaining of the spots spaced radially to the left of the center spot, and Δ represents spot separation in a vertical distance parallel the tangential divided by the disc velocity

8. The method of claim 7 wherein a DC component of the equation obtained through low pass filtering is used as the tracking error.

9. The method of claim 7 wherein the correlating is performed at less than full bandwidth.

10. The method of claim 7 wherein the correlating is performed at least at one half bandwidth.

11. A system for generating a tracking error signal comprising:
a laser system (10) configured to generate a plurality (9) of spaced apart light spots (22, 24, 26);
an optical system (8) in juxtaposition to focus the plurality of spots in a predetermined position on the spinning optical disc (5);
a plurality of detectors configured to receive light reflected from the spinning disc for the light spots;
electronic processing elements configured to correlate respective positions of the light spots in a direction tangential to the spinning optical disc.

12. The system of claim 11 wherein the light spots are spaced apart in a radial direction by a predetermined distance on the spinning optical media disc, wherein the radial direction is measured from a center of the disc to an outside edge of the disc.

13. The method of claim 12 wherein the lights spots have a center position that is determined by taking an average of positions received from reflected light for the plurality of spots.

14. The system of claim 11 wherein the plurality of spot is on odd number of spots such that a center spot is focused on the area and the remaining spots are radially spaced on either side of the area.

15. The system of claim 14 the area is a track and the remaining spots are focused on areas adjacent to the track.

16. The system of claim 15 the remaining spots are focused on land areas adjacent to the track.

17. The system of claim 14 wherein the electronic processing elements correlate respective position of the light spots by application of an equation of the form:
TE(t)=y₀(t)*[y₊(t+Δ)−y₋(t−Δ)]
wherein, y₀(t) represents light reflected from the center spot, y₊(t+Δ) represents light reflected from the remaining of the spots spaced radially to the right of the center spot, y₋(t−Δ) represents light reflected from the remaining of the spots spaced radially to the left of the center spot, and Δ represents spot separation in a distance parallel the tangential divided by a velocity of the spinning disc.

18. The system of claim 17 wherein a DC component of the equation obtained by the electronic processing elements through low pass filtering as used as the tracking error.

19. The system of claim 17 wherein the electronic processing elements correlate at less than full bandwidth.

20. The system of claim 17 wherein the electronic processing elements correlate at least at one half full bandwidth.
